(19) United States
(12) Patent Application Publication
(10) Pub. No.: US 2008/0038014 A1
(43) Pub. Date: Feb. 14, 2008

(54) Developer cartridge and image forming apparatus

(75) Inventors: Atsuna Saiki, Saitama-shi (JP); Kazuhiro Saito, Saitama-shi (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/700,814

(22) Filed: Feb. 1, 2007

(30) Foreign Application Priority Data
Aug. 8, 2006 (JP) 2006-215533

(51) Int. Cl. G03G 15/08; G03G 21/00

(52) U.S. Cl. 399/120; 399/263; 399/358

(57) ABSTRACT

A developer cartridge includes: a developer chamber that contains developer supplied to a developing unit; a waste developer chamber that contains collected waste developer; and a developer supply part that supplies the developer contained in the developer chamber to the developing unit while stirring the developer.

### CROSS-REFERENCE TO RELATED APPLICATIONS

This application is based on and claims priority under 35 USC 119 from Japanese Patent Application No. 2006-215533 filed Aug. 8, 2006.

### BACKGROUND

### TECHNICAL FIELD

The present invention relates to a developer cartridge containing developer to develop a latent image and an image forming apparatus.

### SUMMARY

According to an aspect of the invention, there is provided a developer cartridge including; a developer chamber that contains developer supplied to a developing unit; a waste developer chamber that contains collected waste developer; and a developer supply part that supplies the developer contained in the developer chamber to the developing unit while stirring the developer.

### BRIEF DESCRIPTION OF THE DRAWINGS

An exemplary embodiment of the present invention will be described in detail based on the following figures, wherein:

FIG. 1 is a side view schematically showing an image forming apparatus according to exemplary embodiments of the present invention;

FIGS. 2 is a cross-sectional view of a first example of a waste developer collecting mechanism, showing a developer cartridge and a portion of a process cartridge around the developer cartridge respectively viewed from upper positions;

FIG. 3 is a top view of a second example of the waste developer collecting mechanism;

FIG. 4 is a top view of a driving force transmission system of the waste developer collecting mechanism according to the second example;

FIG. 5 is a side view of the driving force transmission system of the waste developer collecting mechanism according to the second example;

FIG. 6 is a top view of a third example of the waste developer collecting mechanism;

FIG. 7 is a top view of a fourth example of the waste developer collecting mechanism; and

FIG. 8 is a top view of a fifth example of the waste developer collecting mechanism.

### DETAILED DESCRIPTION

Next, an exemplary embodiment of the present invention will be described with reference to the drawings.

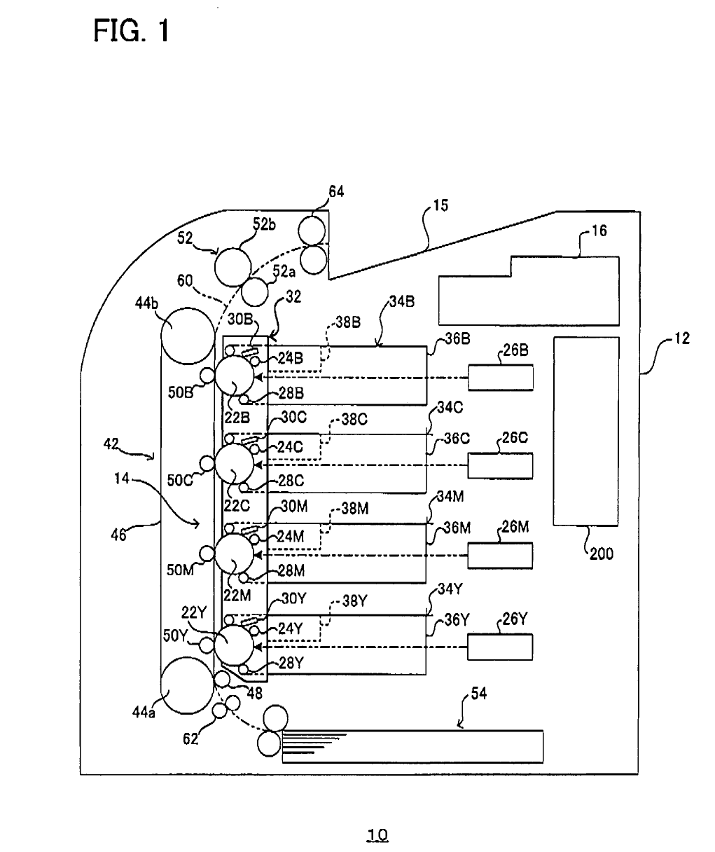

FIG. 1 is a side view schematically showing an image forming apparatus 10 according to the exemplary embodiment of the present invention. The image forming apparatus 10 has an image forming apparatus main body 12. The image forming apparatus main body 12 includes an image forming part 14, a sheet feeder 54 to feed a sheet to the image forming part 14, a power source unit 16 and a controller 200. Further, a sheet discharge part 15, to which a sheet after image formation is discharged, is provided in an upper part of the image forming apparatus main body 12.

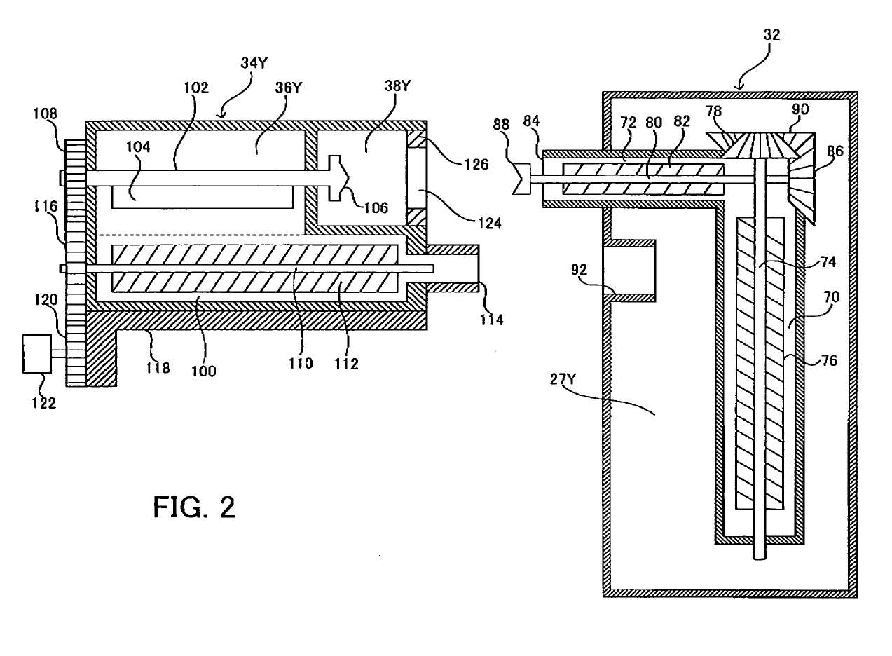

The image forming part 14 is an electrophotographic unit to form a color image. The image forming part 14 has drum-shaped photoreceptors 22Y, 22M, 22C and 22B as image carriers to carry developer images, chargers 24Y, 24M, 24C and 24B as charging units having charging rollers to uniformly charge the respective photoreceptors 22Y, 22M, 22C and 22B, optical writers 26Y, 26M, 26C and 26B as latent-image forming units to optically write latent images on the respective photoreceptors 22Y, 22M, 22C and 22B, developing rollers 28Y, 28M, 28C and 28B included in developing units 27Y, 27M, 27C and 27B (to be described later using FIGS. 2) to develop the latent images written on the respective photoreceptors 22Y, 22M, 22C and 22B with developer (toner), a transfer unit 42 to transfer the developer images formed on the respective photoreceptors 22Y, 22M, 22C and 22B to a sheet, and cleaners 30Y, 30M, 30C and 30B to remove waste developer remaining on the photoreceptors 22Y, 22M, 22C and 22B, by e.g. scraping, after the transfer of the developer images by the transfer unit 42.

The cleaners 30Y, 30M, 30C and 30B respectively flow the scraped waste developer toward a first waste developer conveyance path 70 to be described later.

The optical writers 26Y, 26M, 26C and 26B respectively have a laser exposure device. The optical writer 26Y emits a laser beam corresponding to a yellow image to the photoreceptor 22Y; the optical writer 26M emits a laser beam corresponding to a magenta image to the photoreceptor 22M; the optical writer 26C emits a laser beam corresponding a cyan image to the photoreceptor 22C; and the optical writer 26B emits a laser beam corresponding to a black image to the photoreceptor 22B. In this manner, the optical writers 26Y, 26M, 26C and 263 respectively write latent images on the photoreceptors 22Y, 22M, 22C and 22B.

Among the units included in the image forming part 14, the photoreceptors 22Y, 22M, 22C and 22B, the chargers 24Y, 24M, 24C and 24B, the developing rollers 28Y, 28M, 28C and 28B and the cleaners 30Y, 30M, 30C and 30B are integrated as a process cartridge 32 used as an exchangeable unit. The process cartridge is removably attached to the image forming apparatus main body 12 from a front side (left side in FIG. 1). Further, the process cartridge 32 may include individual units corresponding to respective colors. For example, four units having respective photoreceptors 22Y, 22M, 22C and 22B may be employed.

Further, in the process cartridge 32, developer cartridges 34Y, 34M, 34C and 34B respectively containing developer supplied to the developing rollers 28Y, 28M, 28C and 28B as exchangeable units are removably attached to the image forming apparatus main body 12 from a side surface side.

The developer cartridges 34Y, 34M, 34C and 34B include developer chambers 36Y, 36M, 36C and 36B to contain developer such as toner, and waste developer chambers 38Y, 38M, 38C and 38B.

For example, the developer cartridge 34Y contains yellow toner; the developer cartridge 34M contains magenta toner; the developer cartridge 34C contains cyan toner; and the developer cartridge 34B contains black toner.

The transfer unit 42 is provided in contact with the photoreceptors 22Y, 22M, 22C and 22B of the process cartridge 32. The transfer unit 42 integrated as an unit has two support rollers 44a and 44b, a conveyance belt 46 as a conveyance unit to convey a sheet or image, an attachment roller 48 as an attachment unit to attach the sheet to the conveyance belt 46, and transfer rollers 50Y, 50M, 50C and 50B to transfer developer images formed on the respective photoreceptors 22Y, 22M, 22C and 22B onto the sheet conveyed with the conveyance belt 46.

The attachment roller 48 is provided in press-contact with the support roller 44a via the conveyance belt 46. The attachment roller 48 receives a voltage applied from the power source unit 16 and electrostatically attaches the sheet to the conveyance belt 46.

A transfer bias is applied to the respective transfer rollers 50Y, 50M, 50C and 50B, to sequentially transfer developer images formed on the photoreceptors 22Y, 22M, 22C and 22B to the sheet conveyed with the conveyance belt 46, thus a color developer image is formed with overlaid four color images, i.e., yellow, magenta, cyan and black developer images.

Further, a fixing device 52 to fix the developer image, transferred on the sheet by the transfer unit 42, onto the sheet, is provided in the upper part of the image forming apparatus main body 12. The fixing device 52, having a heating roller 52a and a pressure roller 52b, fixes the developer image to the sheet by heating and pressing the sheet passing between the heating roller 52a and the pressure roller 52b.

Further, a conveyance path 60 to convey a sheet supplied from the sheet feeder 54 to the sheet discharge part 15 is provided in the image forming apparatus main body 12. Along the conveyance path 60, a registration roller 62, the transfer unit 42, the fixing device 52 and a discharge roller 64 are provided sequentially from the upstream side of sheet conveyance direction. The discharge roller 64 discharges the sheet conveyed from the fixing device 52 to the sheet discharge part 15.

Next, waste developer collecting mechanisms will be described in detail.

FIGS. 2 shows a first example of the waste developer collecting mechanism.

The developing unit 27Y including the above-described developing roller 28Y (not shown) is provided around the developer cartridge 34Y in the process cartridge 32. The first waste developer conveyance path 70 to convey waste developer collected by the cleaner 30Y and a second waste developer conveyance path 72 are provided above the developing unit 27Y.

The first waste developer conveyance path 70 is provided in approximately parallel with a longitudinal direction of the photoreceptor 22Y (not shown). Further, the first waste developer conveyance path 70 has a first conveyance member 76 to convey waste developer toward the second waste developer conveyance path 72 by rotating around a shaft 74 as a rotation shaft. A gear 78 is provided at one end of the shaft 74.

The second waste developer conveyance path 72 is provided to be orthogonal to the first waste developer conveyance path 70, and its one end is connected to the gear 78 side of the first waste developer conveyance path 70. Further, the second waste developer conveyance path 72 has a second conveyance member 82 to convey waste developer from the first waste developer conveyance path 70 toward outside the process cartridge 32 by rotating around a shaft 80 as a rotation shaft, such that the waste developer can be discharged from a nozzle-shaped waste developer discharge port 84 provided at the other end of the second waste developer conveyance path 72.

A gear 86 is provided at one end of the shaft 80 on the gear 78 side, and a connection member 88 is provided on the other end of the shaft 80.

A gear 90 is provided between the gear 78 and the gear 86. When the shaft 80 rotates, the rotation of the gear 86 is transmitted via the gear 90 to the gear 78, and the shaft 74 rotates.

Further, the process cartridge 32 has a developer reception port 92 to be engaged with a developer supply port 114 (to be described later) of the developer cartridge 34Y. Developer is supplied from the developer cartridge 34Y through the developer reception port 92 to the developing unit 27Y.

In the developer cartridge 34Y, the developer chamber 36Y and the waste developer chamber 38Y, separated from each other, are arrayed in a longitudinal direction. A developer conveyance path 100, to guide developer contained in the developer chamber 36Y from one end of the longitudinal direction of the developer cartridge 34Y to the outside, is connected approximately in parallel with the developer chamber 36Y. That is, the developer conveyance path 100 is provided in the developer cartridge 34Y so as to be approximately parallel with the developer chamber 36Y and the waste developer chamber 38Y.

Further, the developer chamber 36Y has a first stir-conveyance member 104 to convey the developer toward the developer conveyance path 100 while stirring the developer by rotating around a shaft 102 as a rotation shaft. One end of the shaft 102 on the waste developer chamber 3BY side extends into the waste developer chamber 38Y, and a connection member 106 is formed at the end of the shaft 102. Further, the other end of the shaft 102 opposite to the waste developer chamber 38Y side extends to outside the developer chamber 36Y, and a gear 108 is provided at the end of the shaft 102.

The developer conveyance path 100 has a second stir-conveyance member 112 to convey the developer toward outside the developer cartridge 34Y while stirring the developer by rotating around a shaft 110 as a rotation shaft, so as to supply the developer from the nozzle-shaped developer supply port 114 provided on the waste developer chamber 38Y side in the longitudinal direction.

Note that the second stir-conveyance member 112 prevents leakage of the developer from the developer supply port 114 by stopping. Further, the shaft 110 and the second stir-conveyance member 112 may extend into the developer supply port 114. One end of the shaft 110 opposite to the waste developer chamber 38Y side extends to outside the developer chamber 36Y, and a gear 116 is provided at the end of the shaft 110.

Further, for the developer cartridge 34Y, a driving gear 120 is provided to a frame 118 fixed to the outside of the developer conveyance path 100. The driving gear 120 is driven by a motor 122. When the driving gear 120 rotates, the rotation of the driving gear 120 is transmitted to the gear 116, and further, the rotation of the gear 116 is transmitted to the gear 108.

The waste developer chamber 38Y has a waste developer reception port 124 so as to be opened in the same direction as that of the developer supply port 114 of the developing conveyance path 100. The waste developer reception port 124 has a seal 126 on the inner peripheral side of its opening. The waste developer reception port 124 is engaged with the waste developer discharge port 84 of the process cartridge 32 via the seal 126 such that waste developer is collected from the second waste developer conveyance path 72 into the waste developer chamber 38Y.

Further, when the waste developer reception port 124 is engaged with the waste developer discharge port 84, the connection member 88 of the process cartridge 32 is engaged with the connection member 106 of the developer cartridge 34Y. That is, the connection member 88 and the connection member 106 form a coupling, so as to transmit rotation of the shaft 102 to the shaft 80.

In this manner, as the waste developer reception port 124 is engaged with the waste developer discharge port 84 and the developer supply port 114 is engaged with the developer reception port 92, the developer cartridge 34Y is attached to the process cartridge 32.

Note that the developer cartridges 34M, 34C and 34B and respective portions around of the developer cartridges 34M, 34C 34B of the process cartridge 32 are approximately the same as the developer cartridge 34Y and the portion around of the developer cartridge 34Y of the process cartridge 32. The developer cartridges 34Y, 34M, 34C and 34B are attached to the process cartridge 32, then the image forming apparatus 10 operates.

Next, the operation of the developer cartridge 34Y will be described.

As described above, when the developer cartridge 34Y is attached to the process cartridge 32, the connection member 106 is connected with the connection member 88.

When the power of the image forming apparatus 10 is turned ON, the motor 122 drives the driving gear 120 at predetermined timing. When the driving gear 120 rotates, the gear 116 and the gear 108 rotate. The first stir-conveyance member 104 conveys the developer (yellow toner) contained in the developer chamber 36Y toward the developer conveyance path 100 while stirring the developer. The second stir-conveyance member 112 supplies the developer in the developer conveyance path 100 to the developing unit 27Y via the developer supply port 114 and the developer reception port 92.

As the connection member 106 and the connection member 88 are connected with each other, the driving force of the motor 122 is transmitted via the connection member 106, the connection member 88 and the like to the shaft 80, then the second conveyance member 82 rotates. Further, the driving force of the motor 122 is transmitted via the gear 86, the gear 90, the gear 78 and the like to the shaft 74, then the first conveyance member 76 rotates.

The developing roller 28Y visualizes a latent image formed on the photoreceptor 22Y using the developer supplied to the developing unit 27Y. The cleaner 30Y scrapes waste developer remaining on the photoreceptor 22Y and flows the waste developer to the first waste developer conveyance path 70.

The first conveyance member 76 conveys the waste developer flowed in the first waste developer conveyance path 70 toward the second waste developer conveyance path 72 with the driving force transmitted via the connection member 106, the connection member 88, the gear 86, the gear 90, the gear 78 and the like.

The second waste developer conveyance path 72 conveys the waste developer conveyed from the first waste developer conveyance path 70 toward the waste developer chamber 38Y with the driving force transmitted via the connection member 106, the connection member 88 and the like.

In this manner, the developer contained in the developer chamber 36Y is supplied to the developing unit 27Y, and the waste developer scraped by the cleaner 30Y is collected into the waste developer chamber 38Y.

Further, since the driving gear 120 is driven by the motor 122, provided in addition to a driving system to rotate the photoreceptor 22Y, the influence of the rotation of the first conveyance member 76 and the second conveyance member 82 on the rotation of the photoreceptor 22Y can be reduced.

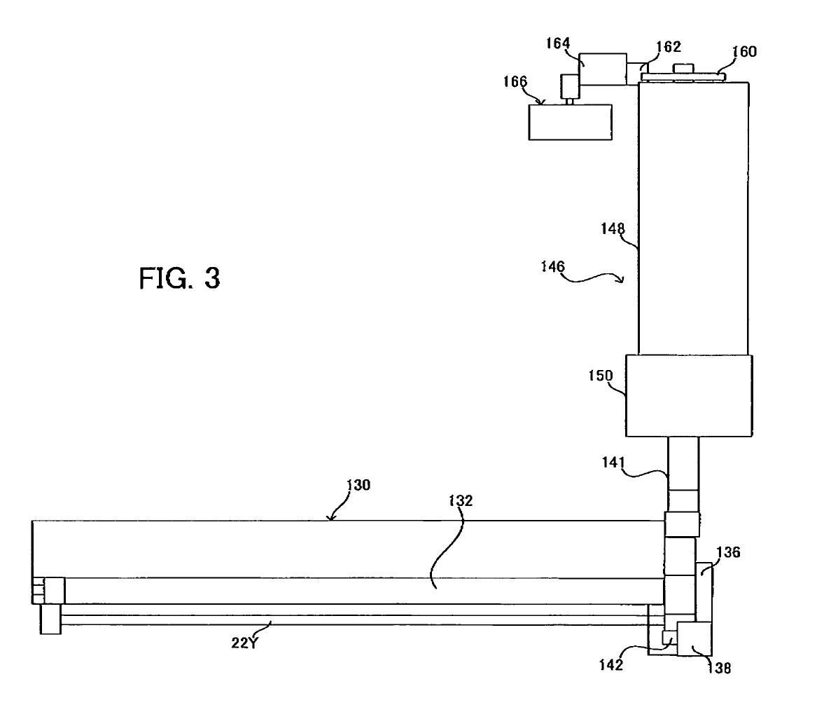

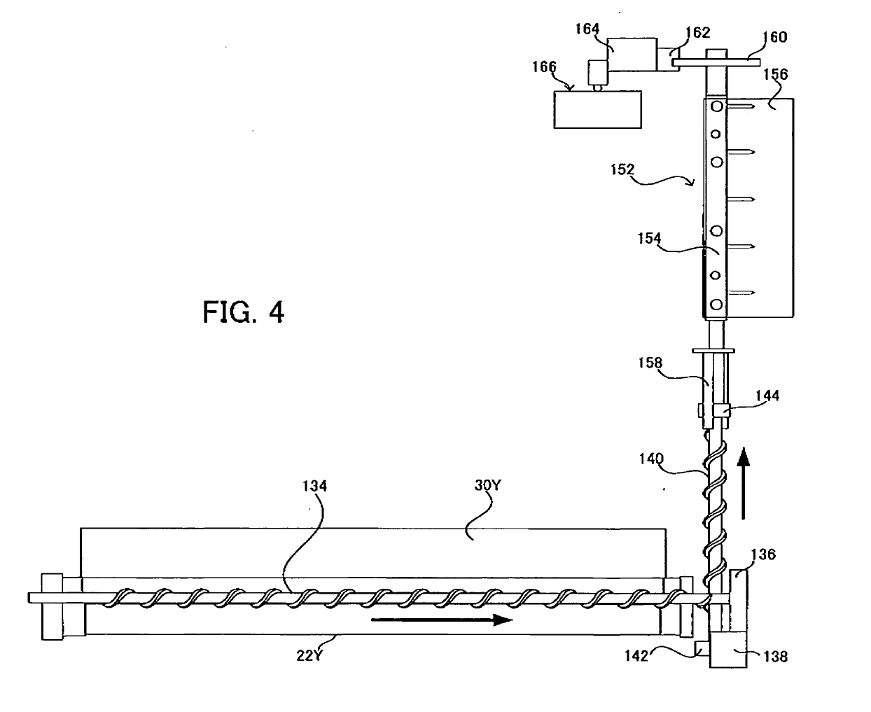

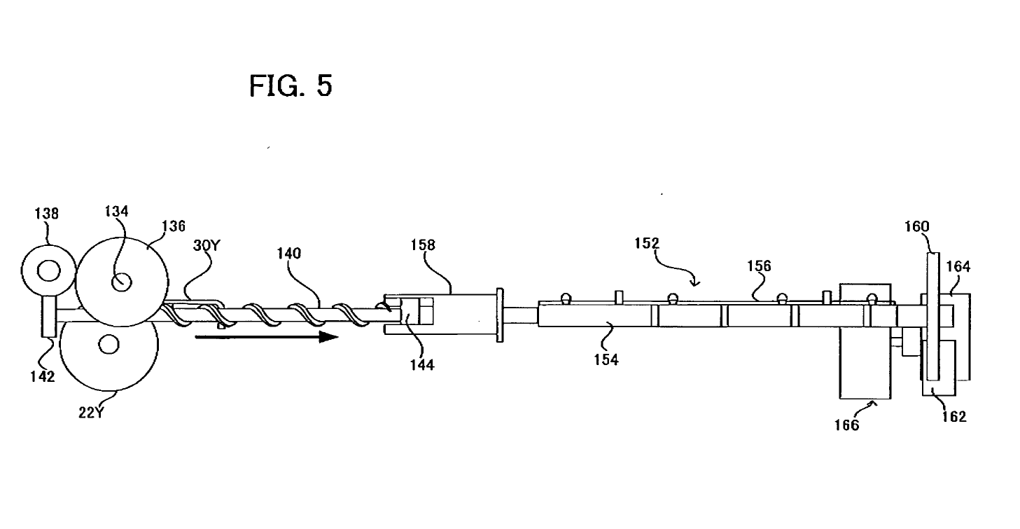

FIGS. 3 to 5 show a second example of the waste developer collecting mechanism.

A photoreceptor unit 130 includes the photoreceptor 22Y, the cleaner 30Y and the like. A waste developer conveyance path 132 is provided in an upper part of the photoreceptor unit 130. The waste developer conveyance path 132 has a waste developer conveyance member 134 to convey waste developer collected by the cleaner 30Y. The waste developer conveyance member 134, having a driving gear 136 fixed to its one end, conveys the waste developer toward the driving gear 136 side by rotation of the driving gear 136. The driving gear 136 rotates by a driving force of a gear 142 fixed at one end of a waste developer conveyance member 140, transmitted via a gear 138.

The waste developer conveyance member 140 is provided in a waste developer conveyance path 141 extending in a direction orthogonal to the waste developer conveyance member 134. The waste developer conveyance member 140 conveys the waste developer conveyed by the waste developer conveyance member 134 toward the opposite side to the gear 142. Further, a connection member 144 is provided in the waste developer conveyance member 140 on the opposite side to the gear 142.

In a developer cartridge 146, a developer chamber 148 and a waste developer chamber 150, separated from each other, are arrayed in a longitudinal direction. The developer chamber 148 includes a stir-conveyance member 152 capable of stir-conveyance of developer contained in the developer chamber 148. The stir-conveyance member 152 stir-conveys the developer by turning a film 156 attached to a shaft 154 Further, a connection member 158 is provided at one end of the shaft 154. The connection member 158 and the above-described connection member 144 form a coupling, so as to transmit the rotation of the shaft 154 to the waste developer conveyance member 140.

Further, a driving gear 160 is fixed to the shaft 154 on the opposite side to the connection member 158. The driving gear 160 receives a driving force of a motor 166 via gears 162 and 164 and rotates.

When the driving gear 160 rotates by the driving force of the motor 166, the driving force is transmitted to the waste developer conveyance member 140 via the shaft 154 and the connecting members 158 and 144. The driving force is transmitted to the waste developer conveyance member 134 via the gears 142 and the 138 and the driving gear 136. Thus the waste developer collected by the cleaner 30Y is collected into the waste developer chamber 150 through the waste developer conveyance paths 132 and 141.

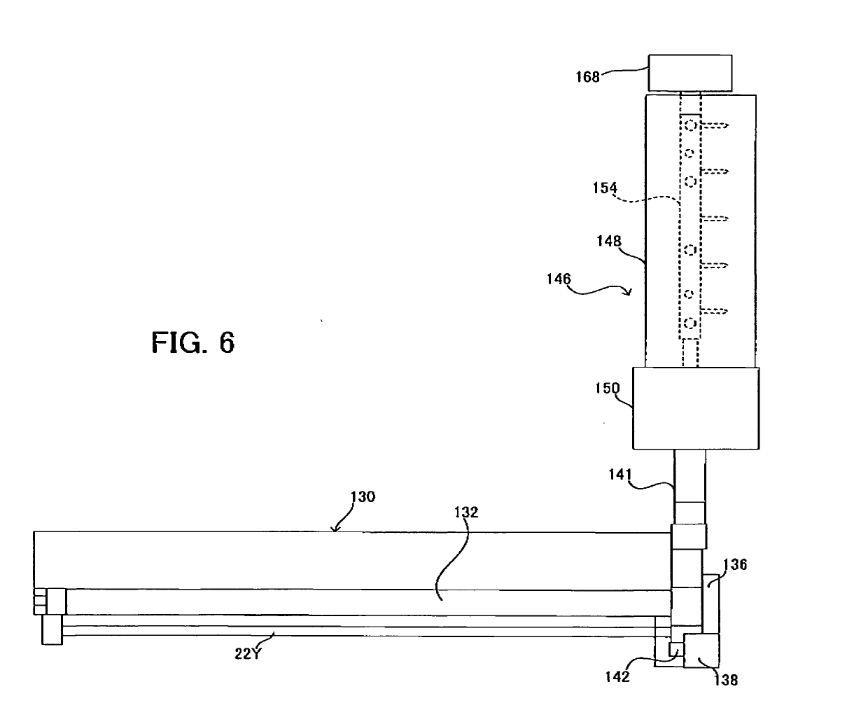

FIG. 6 shows a third example of the waste developer collecting mechanism.

Note that in the third example of the waste developer collecting mechanism, elements substantially the same as the constituent elements of the second example shown in FIGS. 3 to 5 have the same reference numerals.

In the third example of the waste developer collecting mechanism, a motor 168 is directly connected to the shaft 154 and the shaft 154 is directly driven.

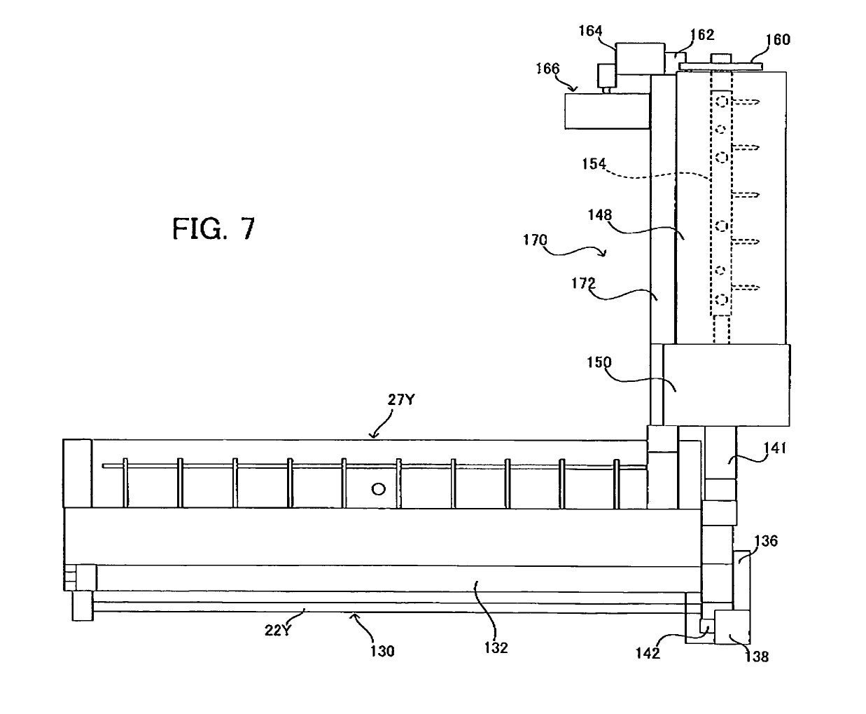

FIG. 7 shows a fourth example of the waste developer collecting mechanism.

Note that in the fourth example of the waste developer collecting mechanism, elements substantially the same as the constituent elements of the first and second examples shown in FIGS. 1 to 5 have the same reference numerals.

In the fourth example of the waste developer collecting mechanism, the developer chamber 148, the waste developer chamber 150 and a developer supply path 172 are integrated as a developer cartridge 170. The developer cartridge 170 is connected to the developing unit 27Y including the developing roller 28Y and the photoreceptor unit 130.

When the gear 162 rotates by the driving force of the motor 166, the developer in the developer chamber 148 is conveyed to the developer supply path 172. The developer is supplied to the developing unit 27Y by a developer conveyance member (not shown) in the developer supply path 172. Further, when the driving gear 160 rotates, the waste developer collected by the cleaner 30Y is collected into the waste developer chamber 150 through the waste developer conveyance paths 132 and 141.

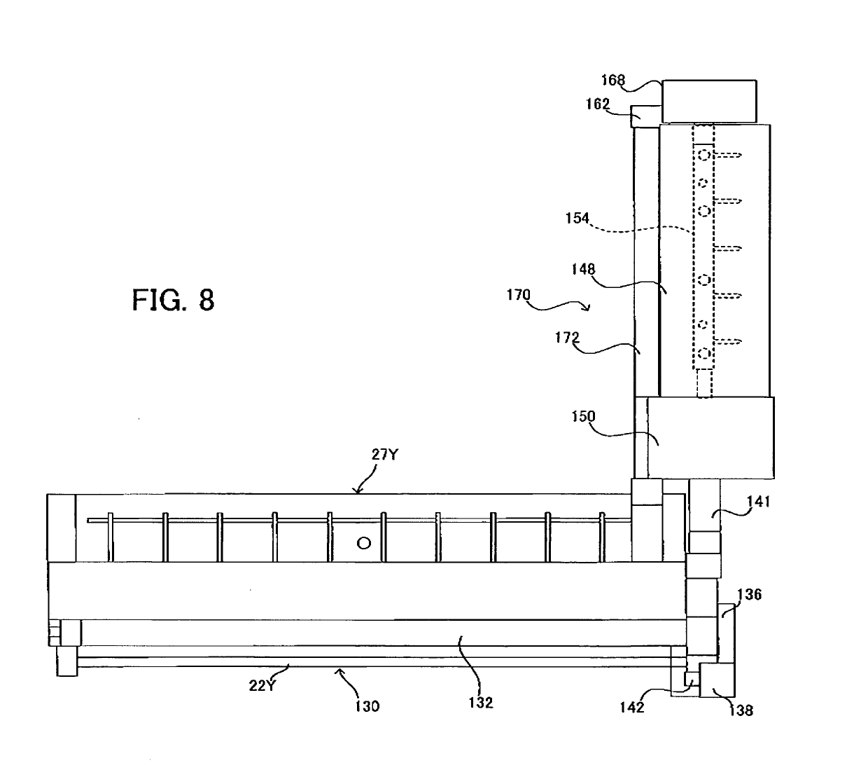

FIG. 8 shows a fifth example of the waste developer collecting mechanism.

Note that in the fifth example of the waste developer collecting mechanism, elements substantially the same as the constituent elements of the fourth example shown in FIG. 7 have the same reference numerals.

In the fifth example of the waste developer collecting mechanism, the motor 168 is directly connected to the shaft 154 and the shaft 154 is directly driven.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developer cartridge, comprising:
a developer chamber that contains developer supplied to a developing unit;
a waste developer chamber that contains collected waste developer; and
a developer supply part that supplies the developer contained in the developer chamber to the developing unit while stirring the developer.

2. The developer cartridge according to claim 1, wherein the developer supply part includes: a stir-conveyance member that conveys the developer while stirring the developer by rotating; and a driver that drives the stir-conveyance member.

3. The developer cartridge according to claim 2, wherein the stir-conveyance member prevents leakage of the developer from the developer chamber by stopping the rotation thereof.

4. The developer cartridge according to claim 2 wherein the driver further drives a waste developer conveyance member that conveys the waste developer to the waste developer chamber.

5. The developer cartridge according to claim 3, wherein the driver further drives a waste developer conveyance member that conveys the waste developer to the waste developer chamber.

6. A developer cartridge, comprising;
a developer chamber that contains developer supplied to a developing unit;
a waste developer chamber that contains collected waste developer; and
a waste developer conveyance unit that conveys the waste developer to the waste developer chamber.

7. A developer cartridge, comprising:
a developer chamber that contains developer supplied to a developing unit;
a waste developer chamber that contains collected waste developer; and
a driver that drives a waste developer conveyance member that conveys the waste developer to the waste developer chamber.

8. An image forming apparatus, comprising:
an image carrier;
a developing unit that visualizes a latent image formed on the image carrier; and
a developer cartridge, detachably attached to the developing unit, that supplies developer to the developing unit,
the developer cartridge including:
a developer chamber that contains the developer supplied to the developing unit;
a waste developer chamber that contains waste developer collected from the image carrier;
a stir-conveyance member that conveys the developer contained in the developer chamber to the developing unit while stirring the developer; and
a driver that drives the stir-conveyance member.

9. The image forming apparatus according to claim 8, further comprising a waste developer conveyance member that conveys the waste developer to the waste developer chamber, wherein the driver further drives the waste developer conveyance member.
